(19) United States
(12) Patent Application Publication
(10) Pub. No.: US 2025/0248789 A1
(43) Pub. Date: Aug. 7, 2025

(54) METHOD AND SYSTEM FOR GENERATING A THREE-DIMENSIONAL IMAGE OF AT LEAST A PARTIAL SECTION OF A ROW OF TEETH, COMPUTER PROGRAM PRODUCT AND MIRROR ELEMENT

(71) Applicant: Carl Zeiss Meditec AG, Jena (DE)

(72) Inventors: Max Pfeiffer, Koenigsbronn (DE); Johannes Rangel, Aalen (DE); Neal Bacher, Oberkochen (DE)

(21) Appl. No.: 19/044,408

(22) Filed: Feb. 3, 2025

(30) Foreign Application Priority Data
Feb. 2, 2024 (DE) 10 2024 200 967.9

(51) Int. Cl. A61C 7/00; G06T 7/00

(52) U.S. Cl. CPC A61C 7/002; G06T 7/97; G06T 2207/10056; G06T 2207/30036

(57) ABSTRACT

A method and system are for generating a three-dimensional image of a partial section of a row of teeth using a stereo camera system of a surgical microscope. The stereo camera system includes a first capturing device and a further capturing device, wherein: a) a respective imaged mirror image is detected in an image generated by the first capturing device and in an image generated by the further capturing device, the imaged mirror images being provided by a mirror element that is arranged in a capture region of the stereo camera system such that a mirror image of the partial section of the row of teeth can be imaged by the first and further capturing devices, b) a pose of the mirror element is determined, c) the three-dimensional image is determined on the basis of at least the imaged mirror images and the pose of the mirror element.

### CROSS-REFERENCE TO RELATED APPLICATIONS

This application claims priority of German patent application no. 10 2024 200 967.9, filed Feb. 2, 2024, the entire content of which is incorporated herein by reference.

### TECHNICAL FIELD

The disclosure relates to a method and a system for generating a three-dimensional image of at least a partial section of a row of teeth using a stereo camera system of a surgical microscope, and to a computer program product and a mirror element for generating the three-dimensional image.

### BACKGROUND

Dental impressions, among other things, are made in dentistry, especially in the case of restorative treatment with for example implants or in the case of orthodontic treatment. For example, these serve to determine a bite position and/or a jaw status, in particular in order to document this at different times of treatment. Dental impressions are also important as a basis for the planning and manufacture of implants and braces/dental splints.

It is known that a malleable mass is pressed onto the row of teeth in order to produce a dental impression. After a waiting period of usually a few minutes, the then dried mass can be removed from the row of teeth and provides a negative model of the row of teeth. This negative can then be used to create a model of the row of teeth, for example a plaster model, which can be used for the progress of the aforementioned applications. The fact that minor changes to the negative, which lead to a deterioration in the precision of the model created thereby, may occur when removing the mass from the row of teeth is problematic. Under certain circumstances, this deterioration may require a repeat of the print. Likewise, the time required to make the impression, especially the previously explained waiting time, and the material consumption are usually undesirable aspects.

So-called intraoral scanners, which are used as alternatives to the illustrated production of an impression using a malleable mass, are also known. Such intraoral scanners use different measurement methods to generate a reconstruction of the surface of a row of teeth and also a digital model, which may then serve as the basis for the described applications. For example, it is conceivable that the model serves as a basis for the production of a dental impression by way of additive manufacturing methods, in particular 3D printers. An implant, which may subsequently be implanted in a timely manner, can also be produced in this way.

As a rule, intraoral scanners generate signals on the basis of the respective physical measuring principle using sensors, and these signals are then processed for reconstruction or creation of the model. For example, known measurement principles of intraoral scanners include confocal laser scanning methods, triangulation methods and tactile measurement methods. To create a model that is as complete and as accurate as possible, it is necessary to capture all sides of a row of teeth or all sides of a tooth using the respective sensor(s). The disadvantage of the known intraoral scanners is that use requires that a sensor carrier with the sensor or sensors used in each case is inserted into the mouth in order to capture a back side of a row of teeth in particular, that is, the side oriented to the mouth interior. This insertion can be very uncomfortable for a patient, as it may cause unpleasant contact with the lips or other regions of the oral cavity. The patient may also perceive the deep insertion into the oral cavity, which might be necessary, as uncomfortable. Another disadvantage lies in the fact that the sensor carrier, or the part of the sensor carrier introduced into the mouth, must be cleaned after use, undesirably delaying reuse.

For the person who creates the dental impression, that is, the dentist or the orthodontist for example, such an intraoral scanner in the treatment room represents additional equipment which on account of its dimensions disadvantageously reduces the space available in the treatment room. Moreover, it may be difficult to integrate such additional equipment into established processes, for example a process for creating a dental impression.

Surgical microscopes are also known. Such surgical microscopes are used by a user during treatment in order to provide an image, in particular a magnified image, of a treatment region, in particular the situs. So-called stereo surgical microscopes generally include two separate optical channels for beam guidance and may provide the user with a depth impression of the examination region. To this end, the beams guided in the two channels may be captured by the eyes of the user via eyepieces. In an alternative to that or in addition, digital surgical microscopes include two image capturing devices which each capture the beams in one of the optical channels in order to generate an image, wherein the user is then provided with a three-dimensional image via a suitable display device on the basis of the two images, which are also referred to as corresponding images hereinafter. Furthermore, other surgical microscopes that are able to optically capture depth information and able to provide three-dimensional images of a treatment region are also known. To this end, optical detection systems which enable a provision of the depth information on the basis of interferometry, triangulation, time of flight (TOF) or microlens arrays, for example, may also be used in the surgical microscope, in particular in an alternative to a stereoscopy system.

An accurate calibration of the stereo camera system is required to ensure a correct depiction, wherein known calibration methods are used to determine intrinsic and extrinsic camera parameters, which are subsequently used by image processing processes to ensure the correct depiction. Intrinsic camera parameters describe parameters relating to the respective camera/image capturing device itself, for example its distortion. Extrinsic camera parameters describe a relationship, in particular spatial relationship, of the image capturing devices and hence of the camera images to one another. Such intrinsic and extrinsic camera parameters are known to a person skilled in the art.

Known prior art includes DE 10 2020 133 627 A1, which discloses a method and an intraoral scanner for detecting the topography of the surface of a translucent, in particular dental, object.

DE 10 2019 008 510 A1 is also known; it also discloses an intraoral scanner, in particular for the three-dimensional scan of an upper or lower jaw with or without teeth along with jaw components in the context of an implant prosthetic.

DE 10 2016 121 687 A1 is also known; it also discloses an intraoral scanner for the digital dental impression in the dental field and a method for generating a digital dental impression via an intraoral scanner.

EP 3 689 295 A1 is also known; it discloses dental observation equipment, wherein a so-called dental microscope is used.

### SUMMARY

It is an object of the disclosure to provide a method and a system for generating a three-dimensional image of at least a partial section of a row of teeth, and a computer program product and a mirror element for generating this three-dimensional image, which allow a temporally fast, accurate and patient-friendly generation of the three-dimensional image. Moreover, improved integration in existing application processes and treatment rooms should be rendered possible, which in turn reduces the costs associated with the provision of such a system.

The aforementioned object is achieved by various embodiments of the disclosure.

A method is proposed for generating a three-dimensional image of at least a partial section of a row of teeth using a stereo camera system of a surgical microscope. The surgical microscope may serve for the magnified depiction of examination objects or regions, especially in medical applications. Hence, partial regions of the mouth or partial regions in the mouth, in particular, may be depicted.

The surgical microscope includes a stereo camera system having a first image capturing device and a further image capturing device. These may each be designed to generate a two-dimensional image. In this case, the images may be generated with a predetermined number of picture elements and hence resolution. For example, an image sensor of an image capturing device may be a CMOS sensor or a CCD sensor. Self-evidently, other sensor types may also be used. As explained above, the surgical microscope may include two optically separate beam paths, wherein the first image capturing device is arranged and/or designed such that an image may be generated on the basis of the beams guided in a first beam path. The further image capturing device may be arranged and/or designed such that a further image may be generated on the basis of the beams guided in the further beam path. In particular, the images may be generated at the same time. Furthermore, the images which are generated by the first and further image capturing devices and subsequently used to generate the three-dimensional image may be referred to as corresponding images. The description also extends to a surgical microscope which, in addition to the stereo camera system or in an alternative, uses a further optical capturing system for generating the three-dimensional image, in particular in order to provide depth information. Such optical capturing systems were already described in the introduction above.

Furthermore, the surgical microscope may include at least one optical element for beam guiding and/or beam shaping, the optical element being able to take the form of a lens element in particular, wherein the at least one optical element may for example serve to generate a magnified image. Optical properties of the surgical microscope, for example a magnification, a focal point, a zoom, an exposure time and a capture region size, may be adjustable.

The stereo camera system may be a calibrated stereo camera system. In particular, the above-described intrinsic and extrinsic parameters of the stereo camera system may thus be predetermined, in particular via a calibration method known to a person skilled in the art. By preference, the aforementioned parameters are determined for all operating states or for predetermined operating states of the surgical microscope, wherein an operating state is characterized by the set (adjustable) parameters of the surgical microscope (for example, zoom, focal point, capture region).

It is possible that the surgical microscope additionally includes at least one eyepiece, through which or into which a user may gaze in order to visually capture the image generated by the surgical microscope. In particular, the user may also capture the examination region in three dimensions through the eyepiece. The surgical microscope may include at least one objective or an objective system, wherein the latter includes the at least one optical element for beam guiding and/or beam shaping. The eyepiece may be or have been optically connected to the objective.

The surgical microscope may be part of a microscopy system, wherein the latter may also include not only the surgical microscope but also a stand for holding the surgical microscope. In this context, the stand may be designed such that it allows a movement of the surgical microscope in space, in particular with at least one degree of freedom, preferably with six degrees of freedom, wherein a degree of freedom may be a translational or a rotational degree of freedom. The degrees of freedom in this context may relate to a reference coordinate system. A vertical axis (z-axis) of this reference coordinate system may be oriented parallel to the gravitational force and counter thereto. A longitudinal axis (x-axis) and a transverse axis (y-axis) of this reference coordinate system may in this context span a plane oriented perpendicular to the vertical axis. Furthermore, the longitudinal axis and the transverse axis may also be oriented orthogonal to one another. Moreover, the stand may include at least one drive device for moving the surgical microscope, for example a servomotor. The stand may also include means for transmitting forces/moments, for example gear and/or coupling units. Hence, the surgical microscope may be mounted or held in movable fashion. Among other things, this allows a user to modify a pose, that is, a position and/or orientation, of the surgical microscope, for example in order to modify a viewing angle on an examination region or in order to view other examination regions.

The surgical microscope may be a dental surgical microscope in particular, which is designed to generate images in dental applications.

A partial section of a row of teeth may in particular include at least one tooth or a part of one tooth. A tooth may also refer to a denture within the meaning of this disclosure.

According to the disclosure, the proposed method includes the following steps.

In a first step, a respective imaged mirror image is detected in an image generated by the first image capturing device of the stereo camera system and in an image generated by the further image capturing device of the stereo camera system.

This mirror image is provided by a mirror element that is arranged in a capture region of the stereo camera system.

Thus, in particular, before the imaged mirror image is detected, the aforementioned mirror element may be arranged in the capture region of the stereo camera system, wherein a mirror image of the at least one partial section of the row of teeth can be imaged by the first and further image capturing devices. In addition, prior to detection, images, in particular corresponding images, may be generated by the image capturing devices, and these images are subsequently used to determine the three-dimensional image. This will be explained in detail hereinafter.

In particular, the mirror element may be a dental mirror or a part thereof. In particular, the mirror element may include or take the form of a mirror surface that reflects radiation. The image of the mirror surface, generated by an image capturing device, that is, the imaged mirror image, is generated by virtue of capturing this reflected radiation. The mirror image generated/provided by the mirror element is thus perceived by virtue of capturing the reflected radiation. Capture by the image capturing devices leads to the generation of an imaged mirror image. However, in addition to the imaged mirror image, the image generated by an image capturing device may also include further regions that do not image the mirror image. In other words, the mirror image may be imaged in a partial region of the image generated by an image capturing device. In the imaged mirror image, the at least one partial section of the row of teeth is imaged. The mirror element may further include a frame section that encloses the mirror surface. The mirror element may also include a handle section so that a user is able to position the mirror element in space. The mirror element is preferably a mirror element with a non-curved mirror surface. By preference, the mirror surface is a round surface. However, the use of polygonal mirror surfaces is also conceivable.

A pose of the mirror element, in particular of the mirror surface, is determined in a second step. The pose may include a translational and a rotational component. For example, a position of a reference point of the mirror element, for example of a mirror surface center, and an orientation of the mirror element, for example the orientation of a mirror surface normal, may be determined as the pose of the mirror element. It is self-evident that positions of a plurality of reference points or orientations of a plurality of partial sections of the mirror element may also be determined as pose, especially in the case of a curved mirror surface. Exemplary methods for determining the pose are explained in detail hereinafter. The pose may be determined in a reference coordinate system. For example, this may be a reference coordinate system of the stereo camera system or of the surgical microscope, or the previously explained reference coordinate system.

In a third step, the three-dimensional image is determined on the basis of at least the imaged mirror images, which were detected in the (corresponding) images generated by the two image capturing devices, and the pose of the mirror element. For example, a stereo reconstruction method may be used to this end, wherein the imaged mirror images form input images for this method. Such methods are known to a person skilled in the art. In particular, corresponding picture elements may be determined in the two input images in such methods. For example, such corresponding pixels or pixel sets may be determined using a feature matching method. Corresponding methods and features are known to a person skilled in the art. Exemplary features are what are known as SIFT features, that is, features (for/of) a scale-invariant feature transformation. However, it is self-evident that other methods may also be used for the determination, for example variational methods or AI-based methods. Three-dimensional coordinates can then be determined in the previously explained reference coordinate system for an object point or object section that is imaged in corresponding picture elements or sets of picture elements. This may also be referred to as reconstruction, wherein a corresponding reconstruction method is performed on the basis of the pose of the mirror element. In particular, at least one method step of the reconstruction method may be performed on the basis of the pose. In particular, the pose may be represented by at least one parameter, wherein the at least one method step is performed on the basis of the parameter, or takes into account the parameter during the implementation. By preference, a stereo triangulation reconstruction method is performed in order to determine the three-dimensional image. Stereo triangulation reconstruction methods are known to a person skilled in the art. In this case, a projection matrix which describes a perspective transformation of three-dimensional object coordinates in a reference coordinate system into two-dimensional image coordinates and which is used during the reconstruction may be determined on the basis of the pose of the mirror element and (known) laws of reflection. In other words, the pose of the mirror element influences the projection matrix of both image capturing devices and hence also the stereo triangulation reconstruction performed on the basis of or dependent on these projection matrices. For example, a so-called homogeneous solution method or a so-called inhomogeneous solution method may be applied for the determination of the three-dimensional coordinates. A rectification method for compensating or eliminating nonlinear distortions in the images, in particular, may be performed before the three-dimensional image is determined.

The proposed method advantageously allows a simple, accurate and patient-friendly generation of a three-dimensional image, in particular an intraoral scan, since, in comparison with the previously explained existing methods, as a rule only a mirror element with small dimensions needs to be arranged in the mouth in order capture a partial section of a row of teeth and image the latter in three dimensions.

The proposed method is used in particular for generating a three-dimensional image of a back side of a row of teeth and/or of biting or chewing surfaces of the row of teeth. The back side of the row of teeth may in particular refer to a side of the row of teeth that faces the mouth interior. A three-dimensional image of a front side of a row of teeth or of a partial section of this row of teeth can be determined without the aforementioned first and second steps. In particular, the three-dimensional image may thus be determined on the basis of corresponding images, which have been generated by the image capturing devices, wherein known methods for stereo reconstruction, in particular, may be used. The image capturing devices for generating the image may be arranged outside the oral cavity, that is, extraorally. Thus, the method may also be referred to as an extraoral scan.

For example, the three-dimensional image may be generated in the form of a CAD data set, for example in STL format. Such a three-dimensional image may then be visualized in particular, for example by output by way of a display device. The three-dimensional image can likewise be used in further processes, for example in CAD/CAM processes, for example to produce a dental impression.

In a further embodiment, the three-dimensional image is additionally determined depending on at least one optical property of the mirror element. In this context, the at least one optical property may be predetermined. Alternatively, the at least one optical property may also be determined in a further step of the proposed method, in particular in image-based fashion, that is, by evaluating at least one image of the mirror element. In particular, an optical property of the mirror element may be a magnification or reduction property. It is self-evident that other optical properties of the mirror element that affect the mirror image imaging may also be taken into account. For example, the optical property may be represented by the projection matrix explained. This advantageously results in a high accuracy of the generated three-dimensional image.

In an alternative to that or cumulatively, the three-dimensional image is additionally determined depending on at least one imaging property of the surgical microscope. In particular, an imaging property may be a set magnification (zoom), a set focal point or any other imaging property that affects the imaged mirror image. This imaging property may also be represented by the projection matrix explained. This also advantageously results in the possibility of generating a three-dimensional image with high accuracy.

In a further embodiment, (corresponding) images of virtual image capturing devices are determined at least on the basis of the pose of the mirror element, wherein the at least one corresponding section of the row of teeth reflected in a catadioptric system is imaged in an image of such a virtual image capturing device. Furthermore, the three-dimensional image is determined on the basis of the images, in particular the corresponding section in the respective images, of the virtual image capturing devices.

The catadioptric system denotes a relay optical system which includes at least the mirror element and optical elements of an image capturing device, for example an objective. In particular, the catadioptric system may include optical elements of the objective of the surgical microscope. A beam path through the catadioptric system may be determined on the basis of optical properties of the optical elements in the catadioptric system, which are known in advance or determinable, and on the basis of the pose of the mirror element and known laws of optics.

The virtual image capturing device is a model of an image capturing device that is mathematical or physical and, in particular, can be evaluated with computer assistance. Depending on the model, it is possible to generate or calculate a virtual image generated by the virtual image capturing device, in particular by way of a computer-implemented calculation of the picture elements. This virtual image depends, inter alia, on parameters of the (modelled) image capturing device and a pose of the (modelled) image capturing device. These parameters of the virtual image capturing device, in particular extrinsic and/or intrinsic parameters, may be dependent on optical properties of the mirror element. Should the mirror surface for example not be curved and have no magnification properties, then the intrinsic parameters of the virtual image capturing device may be equal to the intrinsic parameters of the modelled image capturing device.

In particular, a pose of the virtual image capturing device may be determined on the basis of the pose of the mirror element, in such a way that the virtual image of the virtual image capturing device in this pose images the non-reflected section of the row of teeth, which is reflected by the catadioptric system and hence also reflected by the mirror element. The latter denotes the corresponding section. In addition to the pose of the mirror element, the generation of such a virtual image also depends on the (further) properties of the catadioptric system, for example a set zoom of an objective.

The three-dimensional image may then be determined on the basis of the virtual image, in particular of the corresponding section, using a method known to a person skilled in the art. Exemplary methods have been explained hereinabove. In such a method, in particular, properties of the catadioptric system and hence also of the pose of the mirror element can be taken into account. In other words, the reflected image may be transformed into a non-reflected image, and then the three-dimensional image may be generated on the basis of the non-reflected image. This advantageously results in an accurate and computationally easily implementable determination of the three-dimensional image, which can be generated with a high accuracy in particular.

In a further embodiment, the pose is determined by evaluating at least a property of the imaged mirror image or of the imaged mirror element (or of a section thereof). The at least one property may be determined in image-based fashion, in particular by evaluating the image generated by the respective image capturing device. In particular, the imaged mirror surface or the imaged mirror element may be recognized in such an image, for example by way of object recognition methods known to a person skilled in the art. For example, object recognition methods may be segmentation methods. Thus, for example the imaged mirror surface, the imaged frame section or an imaged handle section may be recognized in image-based fashion. For example, it is possible to form a section, for example a frame section, of the mirror element from material with predetermined optical properties, for example from matte material, in particular in order to allow a reliable detection of this section in the image. Alternatively, a detection may also be implemented by virtue of a user selecting, for example by way of a suitable input device, an image region in which the mirror image or the section to be detected is imaged.

A property of the imaged mirror image or of the imaged mirror element may be a geometric property of the imaged mirror image, for example a dimensional property such as a dimensional variable. A dimensional variable may be a width, a height, a diameter or any other dimensional variable. Additionally, a property may be a shape property, for example a geometric shape such as a circular shape, an ellipsoid shape, a rectangular shape or any other geometric shape. In particular, it is possible to determine a shape factor which represents a relationship between an imaged shape and an actual shape, wherein the pose is determined on the basis of the shape factor.

As explained hereinabove, the pose of the mirror element may influence the imaging by the image capturing devices. Hence the pose may also influence how an actual property of the mirror image or mirror element is mapped onto a property of the imaged mirror image or mirror element. If it is possible to describe a relationship between the actual property and the property of the imaged mirror image by way of a transformation matrix that depends on the pose, then the pose can be determined on the basis of the actual property and the property of the imaged mirror image or imaged mirror element. The actual property may be already known, for example from a model, in particular a CAD model, of the mirror element or be determinable.

If the mirror element or a portion thereof, in particular the mirror surface, is circular and the imaged mirror image is elliptical, then the pose can be determined on the basis of properties of the ellipse, for example the orientation and lengths of the ellipse axes, and the properties of the circular mirror element known in advance, in such a way that the properties known in advance are transformed into the properties of the imaged mirror image. If polygonal mirror elements, in particular equilateral polygonal mirror elements, are used, then at least a part of the pose may be determined by way of a ratio of the edge lengths in the image and the relative position of the edges to one another in the image.

Additionally, the property may be a pose of the imaged mirror image or of the imaged mirror element or of a portion thereof in the image coordinate system. For example, the position may be determined as the position of a reference point, for example a geometric center. For example, the orientation of an axis of a reference section may be determined as the orientation. For example, if the mirror element includes a handle section, the latter may be recognized in the image and its position and/or orientation may be determined. For example, the orientation of a longitudinal axis of the handle section may be determined.

If the pose is determined by evaluating at least a property of the imaged mirror image or of the imaged mirror element, then this advantageously yields a simple determination of the pose since the images generated in any case may be evaluated for the purpose of determining the pose.

Alternatively, the pose may be determined on the basis of markers. To this end, the mirror element may include or take the form of at least one marker element for determining the pose of the mirror element. Self-evidently, it is also possible that the mirror element includes or takes the form of a plurality of markers, wherein the pose of the mirror element is determinable on the basis of a relative position and/or dimensioning of these markers that is known in advance.

The marker element may be an active marker element or preferably a passive marker element. It may be designed to be captured by a capturing device. In particular, the capturing device may be an image capturing device. Thus, the marker element may be an optically capturable marker element in this case. For example, it is conceivable that an optically capturable marker includes a predetermined pattern that allows the pose of the marker and hence of the mirror element to be determined. For example, such optically capturable patterns may take the form of QR codes. Additionally, such optically capturable markers may be reflective marker elements, wherein these for example are designed to be reflective for radiation from a predetermined wavelength range, for example the infrared wavelength range. The image capturing device for optically capturing the marker element may be an image capturing device of the stereo camera system or a different image capturing device. If the mirror element includes a plurality of marker elements, then a pose of the mirror element may also be determined on the basis of the relative position of the imaged marker elements in the image. Additionally, the pose of the mirror element may be determined at least in part by a stereoscopic determination of the pose of at least a marker element.

The image capturing device and the marker element may be used to perform in particular what is known as a monoscopic pose determination. In this case, the pose may be determined by evaluating a two-dimensional image, in particular exactly one two-dimensional image of exactly one image capturing device. In particular, an evaluation of intensity values of pixels of the two-dimensional image may be performed in order to determine the position. Such methods for image-based position detection using exactly one image capturing device and/or based on exactly one two-dimensional image are known to a person skilled in the art. Should a stereo camera system be used, the pose may however also be determined by evaluating the corresponding images of the image capturing devices.

In particular, the pose may thus be determined by optical tracking methods, wherein an image capturing device in particular is used to determine the pose. Such optical tracking may be marker-based tracking, in which specific visually or optically capturable marker elements, for example QR codes or differently designed optical patterns, are used in order to determine the pose.

Alternatively, especially in the above-described determination of the pose by evaluating at least a property of the imaged mirror image or of the imaged mirror element, it is also possible to apply tracking methods without markers, wherein features are captured and used to determine the pose in these methods.

However, in an alternative to an optically capturable marker element, it is also possible to use a marker element that is capturable by other means for the determination of the pose of the mirror element, for example a marker element that is capturable magnetically, capacitively, inductively or in radio-based fashion. For example, a marker element may be designed as an RFID tag.

It is also possible that the mirror element includes a pose sensor, for example an initial sensor or a GNSS sensor, wherein the pose is determined on the basis of output signals of such a sensor. In such an embodiment, the surgical microscope may include a receiver device for the output signals generated by the pose sensor or may be connected to such a receiver device.

Self-evidently, it is also possible to determine the pose using a hybrid method, wherein such a hybrid method combines at least two of the methods for determining a pose, explained hereinabove.

In the case of a marker-based determination of the pose there advantageously is a very accurate determination of the pose, which in turn leads to a generation of an accurate three-dimensional image.

A marker element may also be identifiable, in particular bijectively. For example, a pattern of an optically identifiable marker may encode an identity of the marker. Hence the marker element or the mirror element may be identifiable by capturing the marker element. The identity, which is thus determinable, may be assigned properties of the mirror element, in particular the optical properties explained hereinabove. This assignment and the identity and the properties may be stored in retrievable or readable fashion, for example in a memory device. This advantageously results in a simple determination of the optical properties of the mirror element.

For the purpose of the marker-based determination of the pose, at least a marker element is imaged in a further embodiment by at least one image capturing device of the stereo camera system or by a further image capturing device. The at least one marker element is arranged on or formed by the mirror element. The pose is then determined on the basis of at least one property of the imaged marker element. This has already been explained above. The further image capturing device may in particular be a tracking camera or an environment camera of a microscopy system which takes a different form to the image capturing devices of the stereo camera system. This tracking or environment camera may serve in particular for marker-based tracking of further instruments. In both cases, this advantageously yields the simplest possible integration of an optical determination of the pose when using the surgical microscope or a microscopy system with the surgical microscope.

In a further embodiment, a focal position of the surgical microscope is set on the basis of the pose of the mirror element. In particular, this allows a focal position to be set on a point of the mirror surface or on a point that is spaced apart from the mirror surface by no more than a predetermined distance. In particular, the predetermined distance may depend on a depth of field of the surgical microscope, in particular be smaller than the depth-of-field range. In this case, the depth of field is known in advance or may be determined. Consequently, this allows a high imaging quality to be obtained for the mirror image, which in turn advantageously increases the accuracy of the generated three-dimensional image.

In particular, this also allows the imaged mirror image to be detected more easily and more reliably in the image of an image capturing device.

The radiation captured for generating the images of the stereo camera system is filtered in a further embodiment. The filtering is polarization filtering in a preferred embodiment. However, it is self-evident that other radiation filters may also be used. Advantageously, this may suppress unwanted reflections off a tooth surface in the image, whereby an accuracy of the generated three-dimensional image is increased in turn. In this case, polarization filtering enables a maximum possible or complete suppression of reflections.

In a further embodiment, a filter element is arranged in an illumination beam path of the surgical microscope and/or in an imaging beam path. In particular, a respective filter element may be arranged in each imaging beam path. Both cases yield a good structural integration of a filter element in the surgical microscope or in a microscopy system, which allows the generation of a very accurate three-dimensional image.

In a further alternative to that or cumulatively, a filter element is arranged on the mirror element. For example, the filter element may be arranged on a mirror surface of the mirror element. Advantageously, there is no need for the integration of an additional filter element for generating a highly accurate three-dimensional image in the surgical microscope or in a microscopy system as a result, since the mirror element provides the desired filter properties.

In a further embodiment, the at least one partial section of the row of teeth is illuminated by radiation with predetermined radiation properties. For example, such radiation properties may be (a) predetermined wavelength(s) of the radiation used for illumination purposes, predetermined intensities or, in a preferred embodiment, predetermined polarization properties or further properties of the radiation used for illumination purposes. Advantageously, this can also reduce reflections off the tooth surface, which in turn has an advantageous effect on the accuracy of the generated three-dimensional image.

In a further embodiment, the images generated by the stereo camera system are filtered, wherein the three-dimensional image is determined on the basis of at least the filtered images. In particular, filtering may be performed in order to reduce imaged unwanted reflections. However, in general filtering may also serve to improve the image quality, whereby the accuracy of the three-dimensional image is advantageously increased in turn. A method for filtering for reflection suppression is the so-called tone mapping method.

For example, it is possible to temporarily stain the teeth during image capture. Then, color filtering can be performed, wherein for example the color components in the image that differ from the color of the stain are reduced.

In a further embodiment, at least one quality measure of the three-dimensional image is determined. Furthermore, user information is generated should the quality measure be less than a predetermined threshold value. In this case, the quality measure is thus chosen such that it is proportional to a quality of the three-dimensional image. The user information can be output to the user via an output device, for example via an optical or acoustic output device. This may be part of the surgical microscope or of a microscopy system.

For example, it may be determined whether a point density in a predetermined section of the generated three-dimensional image is less than the predetermined threshold value. The user information can be generated should this be the case since it may be desirable to perform a more accurate reconstruction with a higher density at least in this partial region. In particular, the determined quality measure, for example the point density, may be generated as part of the user information.

Additionally, should the quality measure be determined in partial region-specific fashion, information about the partial region, in particular its pose, may be generated as part of the user information.

This advantageously results in a high accuracy of the generated three-dimensional image being ensured since user information is generated in the event of a possible undesirably low quality, and the method is for example performed again, especially for the partial region for which the unacceptably low quality measure has been determined.

A system for generating a three-dimensional image of at least a partial section of a row of teeth is also proposed, wherein the system includes a stereo camera system and at least one evaluation device. The stereo camera system includes a first and a further image capturing device. The system is configured to perform a method according to one of the embodiments described in this disclosure, in particular the following steps:
a) detecting an imaged mirror image in an image generated by the first image capturing device and in an image generated by the further image capturing device, wherein the mirror image is provided by a mirror element that is arranged in a capture region of the stereo camera system and reflects the at least one partial section of the row of teeth,
b) determining a pose of the mirror element,
c) determining the three-dimensional image on the basis of at least the imaged mirror images and the pose of the mirror element.

The evaluation device may take the form of or include a computing device. A computing device in turn may include or take the form of a microcontroller or an integrated circuit. In this case, the evaluation device may carry out at least one of steps a), b), c), but preferably carry out all of these steps.

The system may be a constituent part of a surgical microscope or of a microscopy system, wherein the surgical microscope or the microscopy system may include the stereo camera system and the evaluation device. Further, the system may include a capturing device for capturing a marker element. Further, the system may include a filter element for filtering the radiation that serves to generate the images of the stereo camera system. Further, the system may include an illumination device for illuminating the partial section with predetermined radiation properties. Furthermore, the system may include an output device for user information.

The system advantageously enables the implementation of a method according to one of the embodiments described in this disclosure, together with the advantages that have likewise already been described.

In a further embodiment, the system includes a mirror element that is to be arranged in the capture region of the stereo camera system.

A computer program product having a computer program is also proposed, wherein the computer program includes software for carrying out one, several or all steps, in particular from the set containing the first step, second step and third step, of a method according to one of the embodiments described in this disclosure when the computer program is executed by or in a computer or in an automation system. In other words, the method may be a computer-implemented method.

A mirror element for generating a three-dimensional image of at least a partial section of a row of teeth is also proposed. According to the disclosure, the mirror element includes or forms at least one marker element for determining the pose of the mirror element. In an alternative to that or cumulatively, the mirror element includes or forms at least one filter element for filtering the reflected radiation. This and corresponding advantages have already been explained hereinabove.

### BRIEF DESCRIPTION OF DRAWINGS

The invention will now be described with reference to the drawings wherein:

FIG. 1 shows a schematic flowchart of a method according to the disclosure;

FIG. 2 shows a schematic flowchart of a method according to the disclosure in a further embodiment;

FIG. 3 shows a schematic block diagram of a system according to the disclosure;

FIG. 4A shows a mirror element in a first pose;

FIG. 4B shows the mirror element depicted in FIG. 4A in a further pose;

FIG. 4C shows the mirror element depicted in FIG. 4A in a further pose;

FIG. 4D shows the mirror element depicted in FIG. 4A in a further pose;

FIG. 5 shows a schematic illustration of a mirror element according to the disclosure;

FIG. 6 shows a schematic block diagram of a virtual image capturing device;

FIG. 7A shows a schematic view of a stereoscopic capture of a row of teeth without a mirror element; and,

FIG. 7B shows a schematic view of a stereoscopic capture of a row of teeth with a mirror element.

### DETAILED DESCRIPTION

Identical reference signs hereinafter denote elements having identical or similar technical features.

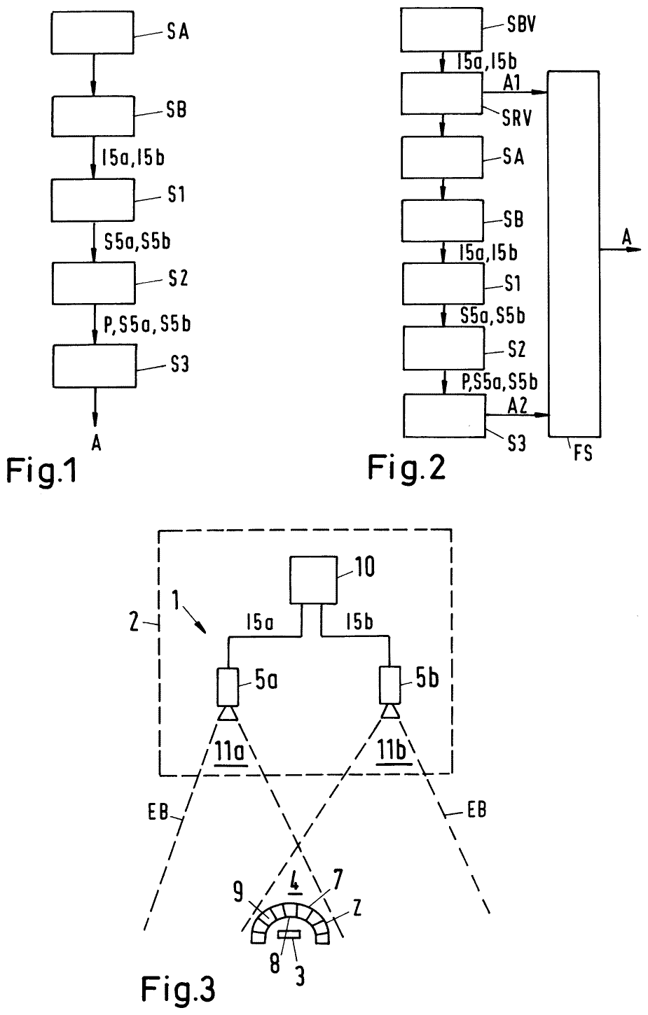

FIG. 1 shows a schematic flowchart of a method according to the disclosure for generating a three-dimensional image A of at least a partial section of a row of teeth Z (see FIG. 3) using a stereo camera system 1 of a surgical microscope 2. A first step S1 of the method is preceded by a mirror element 3 being arranged in a capture region 4 of the stereo camera system 1 in such a way that a mirror image of at least the partial section of the row of teeth Z can be imaged by a first image capturing device 5a and by a further image capturing device 5b of the stereo camera system 1 (arrangement step SA). Following this arrangement, the first image capturing device 5a and the further image capturing device 5b each generate a respective image 15a, 15b, wherein these images 15a, 15b may be referred to as corresponding images (image generation step SB). These are generated from different positions and/or with different orientations. Furthermore, these may be generated simultaneously or with a predetermined maximum time offset. In a first step S1 of the method, an imaged mirror image S5a is then detected in the image 15a generated by the first image capturing device 5a, for example using an object recognition method. In addition to a partial region in which the mirror image provided by the mirror element 3 is imaged, the image 15a generated by the first image capturing device 5a may include further partial regions in this case, which for example image other partial sections of the row of teeth Z, in particular those not reflected by the mirror element 3. An imaged mirror image S5b is also detected accordingly in the image 15b generated by the further image capturing device 5b. The imaged mirror images S5a, S5b thus detected form input variables for determining the three-dimensional image A. In a second step S2 of the method, a pose P, that is, a position and/or orientation, of the mirror element 3 is determined in a reference coordinate system. The reference coordinate system may be a coordinate system of the surgical microscope 2 serving as a reference or a coordinate system of the stereo camera system 1 serving as a reference. It is self-evident that other reference coordinate systems are also conceivable. In addition to the imaged mirror images S5a, S5b, the pose P forms a further input variable for the determination of the three-dimensional image A.

In a third step S3, the three-dimensional image A is then determined on the basis of at least the imaged mirror images S5a, S5b and the pose P of the mirror element 3, for example by way of or using a stereo reconstruction. This has already been explained above.

In this context, it should be mentioned that the sequence of the first and second steps S1, S2 depicted in FIG. 1 is not mandatory. In particular, it is possible to determine the pose P at the same time as or before the detection of the imaged mirror images S5a, S5b.

It is also possible that the three-dimensional image A is additionally determined depending on at least one optical property of the mirror element 3. This optical property then forms a further input variable for the third step S3. In this context, the optical property may be predetermined. In this case, it is possible in particular to identify the mirror element, wherein the at least one optical property may be assigned to the preferably biunique identity of the mirror element 3. Depending on this assignment, the optical property can then be determined using the determined identity of the mirror element 3, for example retrieved from a database, which may be stored in a storage device and represents the assignment of identity to the at least one optical property. Such an identification step, which is not depicted in FIG. 1, may be performed prior to the third step S3. By preference, there may be an image-based identification of the mirror element, for which purpose there is an evaluation of at least one of the generated images 15a, 15b in which the mirror element 3 is imaged. For example, without being mandatory, the identification may be implemented at the same time as the determination of the pose in the second step S2. The identification may be implemented by evaluating at least a property of the imaged mirror element or in marker-based fashion. This is still explained in detail hereinafter in relation to the determination of the pose P.

In an alternative to that or cumulatively, the third step S3 may also be preceded by the determination of an imaging property of the surgical microscope 2, for example a currently set zoom. This imaging property of the surgical microscope 2 may then form a further input variable for the third step S3. Thus, the three-dimensional image A may additionally be determined depending on the at least one optical property of the mirror element 3 and/or depending on the at least one imaging property of the surgical microscope 2.

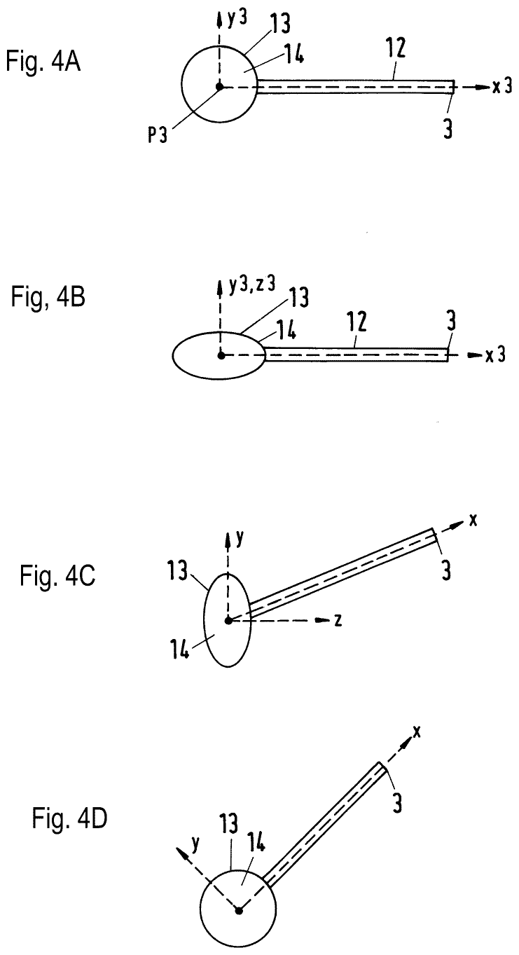

The determination of the pose P of the mirror element 3 in the second step S2 may be implemented in image-based fashion, in particular by evaluating at least one property of the imaged mirror image S5a, S5b or the imaged mirror element 3. The property may be a dimensional property. The property may also be a shape property. These were explained hereinabove. In particular, the properties in the image S5a, S5b may be determined and compared with properties, known in advance, of the mirror image or of the mirror element 3 in a reference position (see for example FIG. 4A), in particular with a mathematically determinable image of the mirror image or the mirror element 3 in this reference position. The pose P of the mirror element 3 may then be determined from a deviation between the actual property in the image and the property, known in advance, determined thus. For example, it is possible to determine a transformation that is used to transform the image of the mirror image or of the mirror element in the reference position into the actual image, the transformation containing information about the current pose P of the mirror element 3.

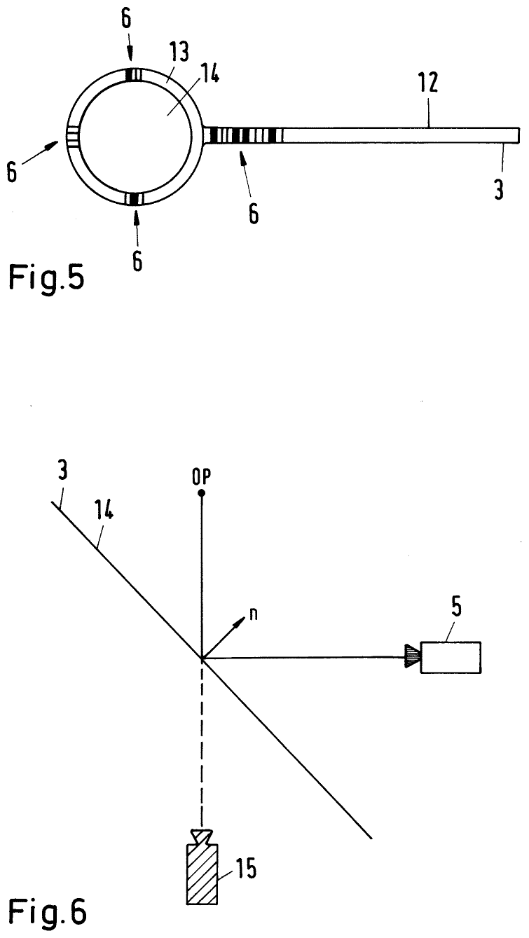

Alternatively, the determination of the pose P may be implemented in marker-based fashion. To this end, it is possible to capture marker elements which are depicted as optically capturable marker elements 6 in an embodiment in FIG. 5. Such marker elements 6 may be active marker elements, that is, marker elements that generate capturable signals under energy consumption, or passive marker elements that can be captured without the marker element consuming energy. The optically capturable marker elements 6 depicted in FIG. 5 which take the form of barcodes or optical patterns are an example of a passive marker element. However, it is also self-evident that optically capturable markers may also be active markers, which for example generate optically capturable signals under energy consumption. In an alternative to optically capturable marker elements 6, however, marker elements capturable in another form may also be used, for example magnetically capturable marker elements. In this case, a marker element may be arranged in or on the mirror element 3, wherein the pose P of the mirror element may then be determined on the basis of the captured marker element.

If the at least one marker element is an optically capturable marker element 6, for example the passive optically capturable marker element 6 depicted in FIG. 5, then, for the purpose of determining the pose P, the at least one marker element can be imaged by at least one image capturing device 5a, 5b of the stereo camera system 1 or by a further image capturing device (not shown), and the pose P can then be determined depending on at least a property of the imaged marker element. In this case, the pose P can only be determined after the respective image 15a, 15b was captured.

It is also conceivable that a focal position of the surgical microscope 2 is set on the basis of the pose P of the mirror element 3. In this case, the images 15a, 15b that are evaluated for the determination of the three-dimensional image A may be generated after the determination of the pose P. If the pose P is determined in image-based fashion, then images which serve to determine the pose P may be generated prior to the determination of the pose P, wherein the focal position is then set on the basis of the pose P, and images 15a, 15b which serve the detection of the imaged mirror image S5a, S5b are subsequently generated.

FIG. 2 shows a schematic flowchart of a method according to the disclosure in a further embodiment. In contrast to the embodiment shown in FIG. 1, images 15a, 15b, that is, corresponding images, from a front side 7 of the row of teeth Z are additionally generated in a further image generation step SBV, wherein, in a reconstruction step SRV, a three-dimensional partial image A1 of the front side is generated on the basis of these images 15a, 15b. Subsequently, the method shown in FIG. 1 is performed, wherein the image A generated therewith is a partial image A2 of a back side 8 of the row of teeth Z and of chewing surfaces 9 of the teeth in the row of teeth Z. The partial images A1, A2 are fused/merged in a fusion step FS to form a resultant image A of the row of teeth Z. For this purpose, corresponding points in the three-dimensional partial images A1, A2, in particular, may be detected in order to fuse the partial images A1, A2. For this purpose, it may be necessary to scale the structures imaged in at least one of the partial images A1, A2, in particular those in the partial image A2 of the back side 8. Such scaling may be implemented, in particular, depending on the distance between the mirror element 13 and the reflected section of the row of teeth Z. This distance may be determinable, in particular on the basis of the pose P of the mirror element 13. The distance may also be determined on the basis of different focal positions of the stereo camera system 1, which will be explained in detail hereinafter. The partial images A1, A2 and the resultant image A may preferably be provided in an STL data format, which advantageously allows the use of these images in further processes, in particular in CAD/CAM processes. The resultant three-dimensional image A or else the partial images A1, A2 may also be displayed to a user via a suitable display device. It is possible to overlay information, such as color information, on the displayed image.

FIG. 3 shows a schematic block diagram of a system according to the disclosure for generating a three-dimensional image A of at least a partial section of a row of teeth Z, wherein the system includes a stereo camera system 1 and at least one evaluation device 10. The system is configured to perform at least steps S1, S2, S3 depicted in FIG. 1 and FIG. 2. It is self-evident that the system may also be configured to perform steps SBV, SRV, FS depicted in FIG. 2. In this case, the steps or at least parts thereof may be performed by the evaluation device 10.

FIG. 3 schematically depicts capture regions EB of the image capturing devices 5a, 5b and optically separated beam paths 11a, 11b of the surgical microscope 2. An illumination device of the surgical microscope 2 that is able to illuminate the row of teeth Z is not depicted. In this case, the illumination device may generate radiation with predetermined radiation properties, in particular predetermined polarization properties. The radiation reflected by the row of teeth Z reaches the image sensors of the image capturing devices 5a, 5b via the beam paths 11a, 11b, whereby an image 15a, 15b of the row of teeth Z may be generated. This may be evaluated by the evaluation device 10. A mirror element 3, which likewise reflects beams from the row of teeth Z, in particular the back side 8 thereof, is also depicted, wherein this reflected radiation also reaches the image sensors via the beam paths 11a, 11b and is imaged there as mirror image. This image can then be detected by the evaluation device 10 as imaged mirror image.

It is possible that the radiation captured for generating the images 15a, 15b of the stereo camera system 1 is filtered. This may be implemented by filter elements which for example are arranged in the beam paths 11a, 11b in each case. Additionally, a filter element may be arranged in an illumination beam path of an illumination device (not depicted) of the surgical microscope 1. Additionally, a filter element may be arranged on/at the mirror element 3. In particular, such a filter element may be a polarization filter element. It is also possible that the evaluation device 10 filters the image 15a, 15b generated by the image capturing devices 5a, 5b, for example in order to suppress reflections.

FIG. 4A shows an image of a mirror element 3 in a reference pose. The mirror element 3 includes a handle section 12 and a round mirror section 13, which in turn includes a mirror surface 14. For example, a center of this mirror surface 14 is a reference point P3 of the mirror element 3. A coordinate system that is stationary with respect to the mirror is depicted, it has a longitudinal axis x3 and a transverse axis y3 and a vertical axis z3 (see FIG. 4B).

FIG. 4B shows an image of the mirror element 3 in a pose P which sets in when the mirror element 3 is rotated about the longitudinal axis x3a from the reference position depicted in FIG. 4A. It is evident that the round mirror surface 14 depicted in FIG. 4A is imaged as an ellipse in that case. Depending on an orientation and a length of the major and minor axis of this ellipse, which may for example be detected by way of an object recognition method, it is then possible to determine the rotation angle through which the mirror element 3 was rotated about the longitudinal axis x3a, wherein it is then again possible to determine the current pose P of the imaged mirror element 3 depicted in FIG. 4B.

In analogous fashion, FIG. 4C and FIG. 4D show imaged mirror elements 3 which were rotated about the transverse axis y3 (FIG. 4C) or about the vertical axis z3 (FIG. 4D) in comparison with the reference position depicted in FIG. 4A. For example, the corresponding rotation angles may be determined on the basis of an orientation of the longitudinal axis x3 (FIG. 4D) and/or on the basis of the orientation and length of the axes of an elliptical image of the mirror surface 14.

What emerges from FIGS. 4a to 4d is that there may be a shape-based determination of the pose P of the mirror element 3, wherein shape properties of the imaged mirror element 3 may be determined and the pose P may subsequently be determined on the basis of these properties.

It is also evident that a center of the mirror surface 14 is detectable. If the focusing is also directed at a non-reflective edge of the mirror surface 14 in addition to a point reflected on the mirror surface 14, for example the center, then it is possible to ascertain the distance of the mirror surface 14, in particular the point of reflection, from the row of teeth Z by way of a difference in the focal positions.

In particular, it is possible to determine a difference between the focal position when focusing the stereo camera system 1 or the surgical microscope 2 on a point of the non-reflective edge, for example a point of the frame section 13, and the focal position when focusing on a point of the object reflected at the mirror surface 14, for example on a point reflected in the center of the mirror surface 14. This difference in the focal positions may represent a distance of the mirror element 13 from the object, in this case a point on the row of teeth Z, wherein the distance may thus be determined on the basis of this difference. Additionally, the distance may also be determined on the basis of the pose P of the mirror element 13. This distance information may be used for scaling within the described stereo reconstruction, in particular in order to match a magnification when reconstructing a reflected section, for example the back side 8 of the row of teeth Z, to a magnification when reconstructing a non-reflected section, for example the front side 7 of the row of teeth Z, that is, to carry out scaling.

FIG. 5 shows a schematic illustration of a mirror element 3 according to the disclosure. The latter includes or forms a marker element 6, which takes the form of an optically capturable barcode, on a handle section 12. The mirror element 3 also includes further optically capturable marker elements 6, which take the form of a barcode, on a frame section 13 of the mirror surface 14. These may be captured in an image of the mirror element 3, wherein these marker elements in particular enable an identification of the mirror element 3 and a determination of the pose P of the mirror element 3. In particular, each marker element 6 may be detected in the case of the mirror element 3 depicted in FIG. 5, wherein the pose P may then be determined by way of a relative arrangement of the marker elements in the image.

FIG. 6 shows a schematic illustration of an image capturing device 5 of a stereo camera system 1 (see FIG. 3) and a mirror element 3, which is arranged in the capture region EB of the image capturing device 5. An object point OP to be imaged, for example a point on the surface of a row of teeth Z (see FIG. 3), is also depicted. A normal n of a mirror surface 14 of the mirror element 3 is also depicted.

A virtual image capturing device 15 is also depicted. A (virtual) image of this virtual image capturing device 15 may be determined by evaluating a mathematical or physical model. In particular, the model is determined in such a way that a virtual image is generated, the latter imaging, in non-reflected fashion, a section of the row of teeth Z, that is, in particular the object point OP that corresponds to the section reflected in the catadioptric system, wherein however the properties of the catadioptric system are taken into account. Then, the three-dimensional image A can be determined on the basis of the virtual image using a method known to a person skilled in the art, for example via or using a stereo reconstruction. This has already been explained above.

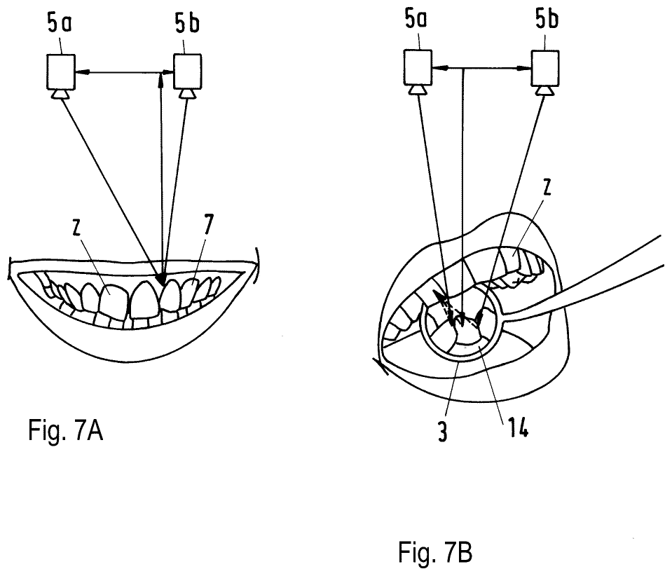

FIG. 7A shows a schematic view of a stereoscopic capture of a row of teeth Z by two image capturing devices 5a, 5b of a stereo camera system 1 without a mirror element 3. A capture of a front side 7 of the row of teeth Z is depicted, for example as implemented in the further image generation step SBV (see FIG. 2) for the reconstruction of a three-dimensional image A of the front side 7.

FIG. 7B shows a schematic view of a stereoscopic capture of a row of teeth Z by two image capturing devices 5a, 5b of a stereo camera system 1 with a mirror element 3. A mirror element 3, which is arranged in the mouth interior and which provides a mirror image of a back side 8 (see FIG. 3) of the row of teeth Z, is shown, wherein this mirror image is then imaged by the image capturing devices 5a, 5b. A three-dimensional image A of the back side 8 is then reconstructed on the basis of the correspondingly imaged mirror images S5a, S5b.

Furthermore, preoperative data may also be used with the images generated by the image capturing devices 5a, 5b in order to generate the three-dimensional images A.

In an alternative and analogously to the stereoscopic detection of a treatment region, it may also be possible to optically capture depth information by way of another capturing system used in the surgical microscope in order to generate a three-dimensional image of at least a partial section of a row of teeth. For this purpose, an alternative image may be generated using this other detection system, as a replacement for the image generated by the first image capturing device and the image generated by the further image capturing device, and a mirror image that is provided by a mirror element arranged in the capture region of the surgical microscope and in particular in the capture region of the capturing system is detected in the alternative image. Then, as explained, the pose of the mirror element and the three-dimensional image may be determined on the basis of at least the imaged mirror image and the pose of the mirror element. Thus, the optical depth information of a partial section of the row of teeth, inter alia, may be rendered capturable for the surgical microscope and for the capturing system in particular and may be embedded in a suitable coordinate system.

It is understood that the foregoing description is that of the preferred embodiments of the disclosure and that various changes and modifications may be made thereto without departing from the spirit and scope of the disclosure as defined in the appended claims.

### List of Reference Signs

1 Stereo camera system
2 Surgical microscope
3 Mirror element
4 Capture region
5, 5a, 5b Image capturing device
6 Optically capturable marker element
7 Front side
8 Back side
9 Chewing surface
10 Evaluation device
11a, 11b Beam path
12 Handle section
13 Frame section
14 Mirror surface
15 Virtual image capturing device
SA Arrangement step
SB Image generation step
S1 First step
S2 Second step
S3 Third step
SBV Image generation step
SRV Reconstruction step
EB Capture region
15a, 15b Images
S5a, S5b Imaged mirror image
P Pose
A1, A2, A Image
OP Object point

1. A method for generating a three-dimensional image of at least a partial section of a row of teeth using a stereo camera system of a surgical microscope, wherein the stereo camera system includes a first image capturing device and a further image capturing device, the method comprising:
detecting a respective imaged mirror image in an image generated by the first image capturing device and in an image generated by the further image capturing device, the imaged mirror images being provided by a mirror element that is arranged in a capture region of the stereo camera system such that a mirror image of the at least one partial section of the row of teeth can be imaged by the first and further image capturing devices;
determining a pose of the mirror element; and,
determining the three-dimensional image on a basis of at least the imaged mirror images and the pose of the mirror element.

2. The method of claim 1, wherein the three-dimensional image is additionally determined in dependence upon at least one of an optical property of the mirror element and an imaging property of the surgical microscope.

3. The method of claim 1, wherein images of virtual image capturing devices are determined at least on the basis of the pose of the mirror element, wherein at least one corresponding section of the row of teeth that is reflected in a catadioptric system is imaged in the image of the virtual image capturing device, wherein the three-dimensional image is determined on a basis of at least the images of the virtual image capturing devices.

4. The method of claim 1, wherein the pose is determined by evaluating at least one property of the imaged mirror image or of the mirror element or in a marker-based fashion.

5. The method of claim 4, wherein, for the marker-based determination of the pose, at least a marker element is imaged by at least one of the first image capturing device and the further image capturing device or an additional image capturing device, wherein the at least one marker element is arranged on or formed by the mirror element, with the pose being determined in dependence upon at least one property of the imaged marker element.

6. The method of claim 1 further comprising setting a focal position of the surgical microscope on a basis of the pose of the mirror element.

7. The method of claim 1, wherein radiation captured for generating the images of the stereo camera system is filtered.

8. The method of claim 7, wherein the filtering is polarization filtering.

9. The method of claim 7, wherein a filter element is arranged at least at one of: in an illumination beam path, in an imaging beam path, and on the mirror element.

10. The method of claim 1, wherein the at least one partial section of the row of teeth is illuminated by radiation with predetermined radiation properties.

11. The method of claim 10, wherein the radiation is generated with predetermined polarization properties.

12. The method of claim 1 further comprising filtering the images generated by the stereo camera system, wherein the three-dimensional image is determined on a basis of at least the filtered images.

13. The method of claim 1, wherein at least one quality measure of the three-dimensional image is determined, wherein user information is generated should the quality measure be less than a predetermined threshold value.

14. A system for generating a three-dimensional image of at least a partial section of a row of teeth, the system comprising:
a stereo camera system including a first and at least one further image capturing device;
at least one evaluation device;
the system being configured to:
detect an imaged mirror image in an image generated by said first image capturing device and in an image generated by said further image capturing device, wherein the mirror image is generated by a mirror element that is arranged in a capture region of the stereo camera system and reflects the at least one partial section of the row of teeth;
determine a pose of the mirror element; and,
determine the three-dimensional image on a basis of at least the imaged mirror images and the pose of the mirror element.

15. The system of claim 14 further comprising said mirror element.

16. A computer program product comprising:
a computer program including program code stored on a non-transitory computer readable medium;
said program code being configured, when said computer program is executed by a processor, to at least one of:
detect an imaged mirror image in an image generated by the first image capturing device and in an image generated by the further image capturing device, wherein the mirror image is generated by a mirror element that is arranged in a capture region of the stereo camera system and reflects the at least one partial section of the row of teeth;
determine a pose of the mirror element;
determine the three-dimensional image on a basis of at least the imaged mirror images and the pose of the mirror element.

17. A mirror element for generating a three-dimensional image of at least a partial section of a row of teeth, the mirror element comprising at least one of:
at least one marker element for determining a pose of the mirror element; and,
at least one filter element for filtering reflected radiation.
